(19) United States
(12) Patent Application Publication
(10) Pub. No.: US 2016/0041085 A1
(43) Pub. Date: Feb. 11, 2016

(54) CORROSION MONITORING APPARATUS AND METHODS

(71) Applicant: PURAFIL, INC., Doraville, GA (US)

(72) Inventor: William G. England, Doraville, GA (US)

(73) Assignee: PURAFIL, INC., Doraville, GA (US)

(21) Appl. No.: 14/774,796

(22) PCT Filed: Mar. 12, 2014
(86) PCT No.: PCT/US14/24019

§ 371 Date: Sep. 11, 2015

Related U.S. Application Data
(60) Provisional application No. 61/777,315, filed on Mar. 12, 2013.

(51) Int. Cl. G01N 17/04

(52) U.S. Cl. CPC G01N 17/043

(57) ABSTRACT

A method for passively monitoring corrosive factors in an environment includes locating an apparatus in an environment. The apparatus includes at least one corrosion classification coupon and a temperature and humidity logging device. The apparatus is maintained in the environment for a period of time and then removed from the environment. The at least one corrosion classification coupon and the temperature and humidity logging device are analyzed to determine whether one or more of corrosive gases, temperature changes or humidity changes were present in the environment during the period of time. The temperature and humidity logging device may be an electronic temperature and humidity logging device. The analysis may be performed by an off-site vendor.

### CROSS REFERENCE TO RELATED APPLICATION

This application claims the benefit of U.S. Provisional application Ser. No. 61/777,315, filed Mar. 12, 2013, the entire contents of which are incorporated herein by this reference.

### FIELD OF THE INVENTION

The present invention generally relates to corrosion monitoring, and more specifically to methods and systems for passively monitoring corrosive factors in an environment such as the presence of corrosive gases and temperature and humidity changes in the environment.

### BACKGROUND

A diverse array of industries rely on electronic and electrical equipment to keep their businesses running on a daily basis. Corrosion of internal parts of such electronic equipment by environmental factors can result in malfunctions, short-circuits, thermal failure, conductive failure, possible pitting, and metal loss. In order to prevent this potentially costly corrosion of electronic and electrical equipment, corrosion can be monitored and identified prior to reaching the point where the electronics and electrical equipment could be damaged or fail to operate.

Corrosion includes the deterioration of a base metal which results from a reaction of the base metal with gases in its environment. Sometimes these gases are referred to as “Airborne Molecular Contaminants” (AMCs). The exposure of base metals to AMCs and water vapor results in the buildup of chemical reaction by-products. These by-products, in turn, can form insulating layers on circuits that may lead to malfunctions. The three types of common gases that are frequently the cause of corrosion include: 1) Acidic gases—including hydrogen sulfide, sulfur and nitrogen oxides, chlorine, and hydrogen fluoride; 2) Caustic gases—including ammonia; and 3) Oxidizing gases—including ozone and nitric acid. Exemplary environmental AMCs include:

| | | Cate- | |
|---|---|---|---|
| Constituent | Symbol | gory | Common Sources |
| Acetic acid | CH₃COOH | Gas | Semiconductor manufacturing, |
| | | | wood and wood products, |
| | | | photo developing |
| Active organic | N₂ | Gas | Automobile emissions, animal |
| nitrogen | | | waste, vegetable combustion, |
| | | | sewage, wood pulping |
| Ammonia | NH₃ | Gas | Microbes, sewage, fertilizer |
| | | | manufacture, geothermal |
| | | | steam, refrigeration equipment, |
| | | | cleaning products, |
| | | | reproduction (blueprint) |
| | | | machines |
| Arsine | AsH₃ | Gas | Semiconductor manufacturing |
| Carbon | C | Solid | Incomplete combustion |
| | | | (aerosol constituent), foundry |
| Carbon | CO | Gas | Combustion, automobile |
| monoxide | | | emissions, microbes, trees, |
| | | | wood pulping |
| Chloride ions | Cl | Liquid | Aerosol content, oceanic |
| | | | processes, ore processing |
| Chlorine, | Cl₂, ClO₂ | Gas | Chlorine manufacture, |
| Chlorine | | | aluminum manufacture, paper |
| dioxide | | | mills, refuse decomposition, |
| | | | cleaning products |
| Ethylene | C₂H₂ | Gas | Fruit, vegetable, cut flower |
| | | | storage & transportation |
| Formaldehyde | HCHO | Gas | Wood products, floor & wall |
| | | | coverings, adhesives, sealants, |
| | | | photo developing, tobacco |
| | | | smoke |
| Halogen | HBr, HI | Gas | Automotive emissions |
| compounds | | | |
| Hydrocarbons | HC, THC | Gas | Automotive emissions, fossil |
| (alcohols, | | | fuel processing, tobacco smoke, |
| aldehydes, | | | water treatment, microbes. |
| ketones, | | | Many other sources, both |
| organic acids) | | | natural and industrial, paper |
| | | | mills |
| Hydrogen | HCl | Gas | Automobile emissions, |
| chloride | | | combustion, oceanic processes, |
| | | | polymer combustion |
| Hydrogen | HF | Gas | Fertilizer manufacture, |
| fluoride | | | aluminum manufacture, |
| | | | ceramics manufacture, steel |
| | | | manufacture, electronic device |
| | | | manufacture, fossil fuel |
| Hydrogen | H₂S | Gas | Geothermal emissions, |
| sulfide | | | microbiological activities, fossil |
| | | | fuel processing, wood pulping, |
| | | | sewage treatment, combustion |
| | | | of fossil fuel, auto emissions, |
| | | | ore smelting, sulfuric acid |
| | | | manufacture |
| Inorganic dust | | Solid | Crystal rock, rock and ore |
| | | | processing, combustion, |
| | | | blowing sand and many |
| | | | industrial sources |
| Mercaptans | S₈, R—SH | Gas | Foundries, sulfur manufacture |
| Oxides of | NOₓ | Gas | Automobile emissions, fossil |
| nitrogen | | | fuel combustion, microbes, |
| | | | chemical industry |
| Ozone | O₃ | Gas | Atmospheric photochemical |
| | | | processes mainly involving |
| | | | nitrogen oxides and |
| | | | oxygenated hydrocarbons, |
| | | | automotive emissions, |
| | | | electrostatic filters |
| Sulfur dioxide | SO₂, SO₃ | Gas | Combustion of fossil fuel, auto |
| | | | emissions, ore smelting, |
| | | | sulfuric acid manufacture, |
| | | | tobacco smoke |

### Sources of Reactive Environmental Contaminants (ISA 1985)

The America Society of Heating, Refrigerating and Air-Conditioning Engineers (ASHRAE) has established guidelines for gaseous and particulate contamination of data centers, as set forth in, for example, “2011 Gaseous and Particulate Contamination Guidelines For Data Centers,” which is incorporated by reference in its entirety.

Furthermore, it is useful to be able to determine which of these AMCs are present because the AMCs have different corrosive effects on different metals.

While corrosion is primarily caused by AMCs, it is accelerated by changes in temperature or humidity. Generally, rapid shifts in temperature or humidity cause portions of the circuits in the electronics to fall below the dew point temperature. This temperature drop results in condensation on the circuits. The condensation then absorbs the AMCs and the AMCs become electrolytes where crystal growth and electroplating occur. Relative humidity above 50% greatly accelerates this condensation and above 80% relative humidity, corrosive damage will occur regardless of the level of AMCs.

The Instrumentation, Systems, and Automation Society has set standards to serve as a blueprint to determine the risk of malfunction due to corrosion for electronics and electrical equipment. Four levels of corrosion severity have been established in ISA-71.04-1985 (herein incorporated by reference). These four levels include Mild, Moderate, Harsh, and Severe as set forth in Table 1:

TABLE 1
Copper Coupon Reactivities

| | Se- | Copper | |
|---|---|---|---|
| | verity | Reactivity | |
| Class | Level | (\acute{Å}/month) | Comments |
| G1 | Mild | <300 | An environment sufficiently well-controlled |
| | | | such that corrosion is not a factor in |
| | | | determining equipment reliability. |
| G2 | Mod- | 300-1000 | An environment in which the effects of |
| | erate | | corrosion are measurable and corrosion |
| | | | may be a factor in determining equipment |
| | | | reliability. |
| G3 | Harsh | 1000-2000 | An environment in which there is a high |
| | | | probability that corrosive attack will |
| | | | occur. These harsh levels should prompt |
| | | | further evaluation resulting in |
| | | | environmental controls or specially |
| | | | design and packaged equipment. |
| GX | Severe | >2000 | An environment in which only specially |
| | | | designed and packaged equipment would be |
| | | | expected to survive. Specifications for |
| | | | equipment in this class are a matter of |
| | | | negotiation between user and supplier. |

The ASHRAE guidelines and “2011 Gaseous and Particulate Contamination Guidelines For Data Centers” (referred to above) each incorporate this standard.

A cost effective diagnostic used to determine the level of corrosion includes copper environment reactivity coupons, also known as “Corrosion Classification Coupons,” which are placed in an environment and left for 30 days. After 30 days, the copper coupons are removed. During this time, if AMCs are present in the environment, a corrosive film is formed. This corrosive film is measured and the total corrosion film thickness is determined. In addition, the thickness attributed to individual AMCs can be determined. Based on the thickness, the reliability of the equipment can be determined based on the ISA-71.04-1985 chart set forth in Table 1. As an example, these coupons may be used in control rooms, motor control centers, rack rooms, and other areas housing sensitive electronics.

Prior to 2006, electronic and electrical equipment was less fragile with respect to corrosive gases due to lenient regulations in how that equipment could be produced and what materials could be included in that equipment to prevent corrosion due to AMCs. However, in 1998, the European Union determined that unacceptable amounts of hazardous waste were being dumped into landfills creating a huge amount of environmental contamination. Some of this contamination was related to the use of hazardous chemicals in electronics and electrical equipment. In response, the European Union passed the Waste Electrical and Electronics Equipment directive (WEEE, 2002/96/EC) on “the Restriction of the use of Hazardous Substances in Electrical and Electronic Equipment” (“RoHS”) which was implemented in July 2006. More specifically, RoHS restricts the use of mercury (Hg), lead (Pb), hexavalent chromium (Cr(VI)), Cadmium (Cd), polybrominated biphenyls (PBB) and polybrominated diphenyl ethers (PBDE). RoHS is required in the EU along with several other countries currently.

The implementation of RoHS made a process used for many years obsolete due to its noncompliance with RoHS. Prior to the passage of RoHS, most printed circuit boards (“PCBs”) underwent hot air solder leveling (“HASL”) which protected the thin copper foil in PCBs from being exposed to AMCs. After the passage of RoHS, two new processes for finishing PCBs emerged. The first process included using an organic solder preservative on the PCB. A second process included using electroless-nickel immersion gold. These two processes, however, have a high failure rate. Two newer processes developed include immersion silver and organically coated copper. Unfortunately, both of these processes have some problems succumbing to corrosion as well. It has been shown that the gold and silver coatings that are compliant with RoHS could not be expected to survive mid to high Class G2 environments described herein.

Due to the new processing methods and increased risk to electronics and electrical equipment, especially PCBs, it is necessary to take protective steps in the environments in which the equipment is maintained. It is also helpful to be able to determine in what concentration corrosive agents are present in any particular environment. Electrical equipment is far more sensitive than the human body to these agents and at the point the human body can detect these substances, they are far beyond the levels at which extensive corrosive damage can occur.

In response to the need for additional monitoring of environmental factors affecting the electronics and electrical equipment due to the passage of RoHS, many companies began monitoring the environment with copper and silver environment reactivity coupons. Silver is capable of detecting the presence of chlorine, which is potentially dangerous to these sensitive electronics, but cannot be tested for using copper. Silver is also capable of detecting the presence of these corrosive gasses at much lower levels than the copper coupons. Furthermore, corrosion of silver is not dependent on humidity while copper corrosion is dependent on humidity. Therefore, any corrosion occurring in the data center on silver can be attributed to the presence of certain gasses if there is not corrosion on the copper coupon due to controlled humidity.

Another type of monitoring that can be performed is active monitoring where data is continuously collected in the data center. However, active monitoring is most useful when the AMCs and other environmental factors have already been analyzed and controlled. Active monitoring equipment is very expensive and can be destroyed if placed in a harsh environment that has not already been remediated for AMCs, humidity, and temperature. The harsh environment can destroy expensive sensors and other portions of the equipment rendering it unusable and unfixable. Active monitoring is more appropriate for monitoring an already controlled environment to ensure that the remediation measures have been effective. It can also be used to determine if further remediation is necessary. Furthermore, active monitoring cannot be used to determine the particular AMCs in the environment which can effect what type of remediation will be most effective.

Corrosion generally takes two forms in this type of electronic and electrical equipment. The first type of corrosion occurs when the acid gases react with the metals and form non-conductive salts. The second type is referred to as “whisker growth.”

Non-conductive salts often form when an oxide or sulfide layer forms on any non-precious metals exposed to the atmosphere. It forms a layer of corrosion which then stops or it can continually corrode the base metal as the corrosion spreads out from its origin. The corrosion product eventually interferes with electrical connections by creating contact resistance. Contact resistance prevents the flow of an electrical current thus disrupting operations. This type of corrosion can also occur in small pores in the surface platings or vias.

Whisker growth occurs when electrically conductive, crystalline structures of tin grow where tin is used as a final finish. These structures can grow across the surface and connect portions of a board or chip that are meant to be kept at different electrical potentials and can cause short-circuits. Whisker growth generally is caused by the presence of sulfide molecules on a silver surface. These sulfide molecules can migrate and collect allowing nucleation. “Whiskers” can grow up to 20 mm in length.

### SUMMARY

The terms “invention,” “the invention,” “this invention” and “the present invention” used in this patent are intended to refer broadly to all of the subject matter of this application. Statements containing these terms should not be understood to limit the subject matter described herein or to limit the meaning or scope of the invention described below. This summary is a high-level overview of various aspects of the invention and introduces some of the concepts that are further described in the Detailed Description section below. This summary is not intended to identify key or essential features of the invention, nor is it intended to be used in isolation to determine the scope of the invention. The subject matter should be understood by reference to the entire specification of this application and all drawings.

A method and an apparatus are provided herein for passively monitoring corrosive factors in an environment where those factors could cause equipment failures, deterioration of artifacts, electrical shorts and the like. The method for passively monitoring corrosive factors in an environment includes locating an apparatus in the environment, the apparatus including at least one corrosion classification coupon and a temperature and humidity logging device, maintaining the apparatus in the environment for a period of time, removing the apparatus from the environment; and analyzing at least one corrosion classification coupon and the temperature and humidity logging device to determine whether corrosive gases, temperature changes and/or humidity changes were present in the environment during the period of time.

The apparatus for passively monitoring corrosive factors in an environment includes a first corrosion classification coupon, a second corrosion classification coupon and an electronic temperature and humidity logging device.

### BRIEF DESCRIPTION OF THE DRAWINGS

Illustrative embodiments of the present invention are described in detail below with reference to the following drawing figures:

FIG. 1 is an excerpt of a humidity log from a temperature and humidity logging device according to an embodiment of the invention.

FIG. 2 is an excerpt of a temperature log from a temperature and humidity logging device according to an embodiment of the invention.

FIG. 3 is an exemplary corrosion analysis of copper and silver coupons according to an embodiment of the invention.

FIG. 4 is an Equipment Reliability Correlation based on the corrosion analysis of FIG. 3.

FIG. 5 is an exemplary device for passively monitoring corrosive factors in an environment according to an embodiment of the invention.

### DETAILED DESCRIPTION

The subject matter of embodiments of the present invention is described here with specificity to meet statutory requirements, but this description is not necessarily intended to limit the scope of the invention. The invention may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

In one embodiment, a method for passively monitoring the types of air contaminants and amounts of those contaminants as well as the temperature and humidity of a control room or other room housing sensitive electronics and/or electronic equipment is implemented. This method can be used for a variety of purposes related to the preservation and/or maintenance of electronic equipment or any other items that could be effected by AMCs.

One exemplary application includes using the method and apparatus described below to determine whether or not remedial measures are needed in order to preserve electronic or electrical equipment. Another exemplary application is to determine if an electrical equipment failure is imminent or likely over a period of time due to corrosive influences on the equipment. Some exemplary types of electronic equipment that can be passively monitored by the method and apparatus described below include: process computer systems, microprocessor-based process control or instrumentation systems, electronic equipment rack rooms, data centers, motor control centers, substations with programmable logic controllers, electronic control systems, thyristor drives, chopper drives, inverters, AC phase controllers or uninterruptable power supplies, or heavy current switchgear. Another exemplary application includes using this method and apparatus in museums, archives and libraries to determine whether or not remedial measures are needed for archive material, museum collections (such as art work or fabrics) or other sensitive items that could be adversely affected by AMCs. Another exemplary application is to determine which types of AMCs as well as their levels are present in a control room, motor control center, rack room, or other area housing sensitive electronics. Additional exemplary embodiments include the use of the method and apparatus in petrochemical plants, cleanrooms, water treatment plants, pulp and paper plants, pharmaceutical plants, oil and gas, libraries as well as other commercial applications.

The method involves using at least one corrosive classification coupon in conjunction with a device to record temperature and humidity over a given period of time during which the corrosive coupons are exposed to such an environment.

In one embodiment, the corrosion classification coupon can be composed of copper, silver, and/or any other reactive metal that can be used to determine the presence of particular corrosive gases. More than one corrosion classification coupon can be used such as using both copper and silver coupons. An exemplary brand is the “Purafil Environmental Reactivity Coupon” (“ERC”), commercially available from Purafil, Inc., 2654 Weaver Way, Doraville, Ga. 30340, which uses both copper and silver-plated sensors to measure the level of AMCs. Any other brand of ERC would be sufficient in this analysis. In this embodiment, the ERC is placed in the area to be studied and returned to the manufacturer after a set period of time, such as 30 days, for analysis. The ERC is then analyzed by the manufacturer to determine the reactivity rate of the coupons in the environment in question. This analysis correlates to the following chart:

Clean room Air Quality Standards

| Copper Corrosion | | | Silver Corrosion | | |
|---|---|---|---|---|---|
| | | Reactivity | | | Reactivity |
| Air Quality | | Rate (Ang- | Air Quality | | Rate (Ang- |
| Classification | | stroms/30 days) | Classification | | stroms/30 days) |
| C1 | Pure | <90 | C1 | Pure | <40 |
| C2 | Clean | <150 | C2 | Clean | <100 |
| C3 | Moderate | <250 | C3 | Moderate | <200 |
| C4 | Harsh | <350 | C4 | Harsh | <300 |
| C5 | Severe | >350 | C5 | Severe | >300 |

Pure: Airborne Molecular Contaminants (“AMCs”) do not pose a measurable threat to processes.
Clean: AMCs are measureable, but do not pose an immediate threat to processes.
Moderate: AMCs are slightly above the levels considered acceptable for reliable operation.
Harsh: AMCs are above the levels considered acceptable for reliable operation.
Severe: AMCs pose an immediate threat to reliable operations.

These corrosive classification coupons can be used to determine the total amount of AMCs present in the area being tested, the types of contaminants in the area being tested, and the relative amounts of the different types of contaminants in the area being tested. However, corrosion classification coupons only offer a snapshot of the cumulative amount of AMCs that were present over the entire period of time that the coupons were present in the location. While this information is necessary in order to determine whether or not corrective actions are required, it does not provide a complete picture of the environment in the area being studied because it does not record whether other factors relevant to corrosion were present at any given time in the studied environment.

Thus, one embodiment of the method uses these corrosion classification coupons in conjunction with a temperature and humidity logging device such as but not limited to an electronic temperature and humidity logging device. One embodiment uses a Maxim iButton®, commercially available from Maxim Integrated Products, Inc., 120 San Gabriel Drive, Sunnyvale, Calif. 94086, to log temperature and data. An exemplary iButton® is the D51923 temperature/humidity logger iButton® sold by Maxim Integrated Products. Of course, any other suitable temperature and humidity logger could be used in embodiments of the invention.

For the purposes of obtaining this additional information from an area being studied for environmental contaminants, the temperature and humidity logging device would be placed in close proximity to the environmental reactivity coupons for a period of time. Close proximity is defined herein as being within the area being studied for environmental contaminants, such as in the same room or the same part of the room being studied so that contaminating gases are in contact with both the environmental reactivity coupons and the temperature and humidity logging device at approximately the same concentration. One exemplary period of time is 30 days. After 30 days, the temperature and humidity logging device as well as the environmental reactivity coupons would be removed from the location and provided to an off-site vendor capable of analyzing these two components. In another embodiment, the company analyzing its own area for contaminants could conduct the analysis in-house rather than supplying the temperature and humidity logging device and the environmental reactivity coupons to a vendor.

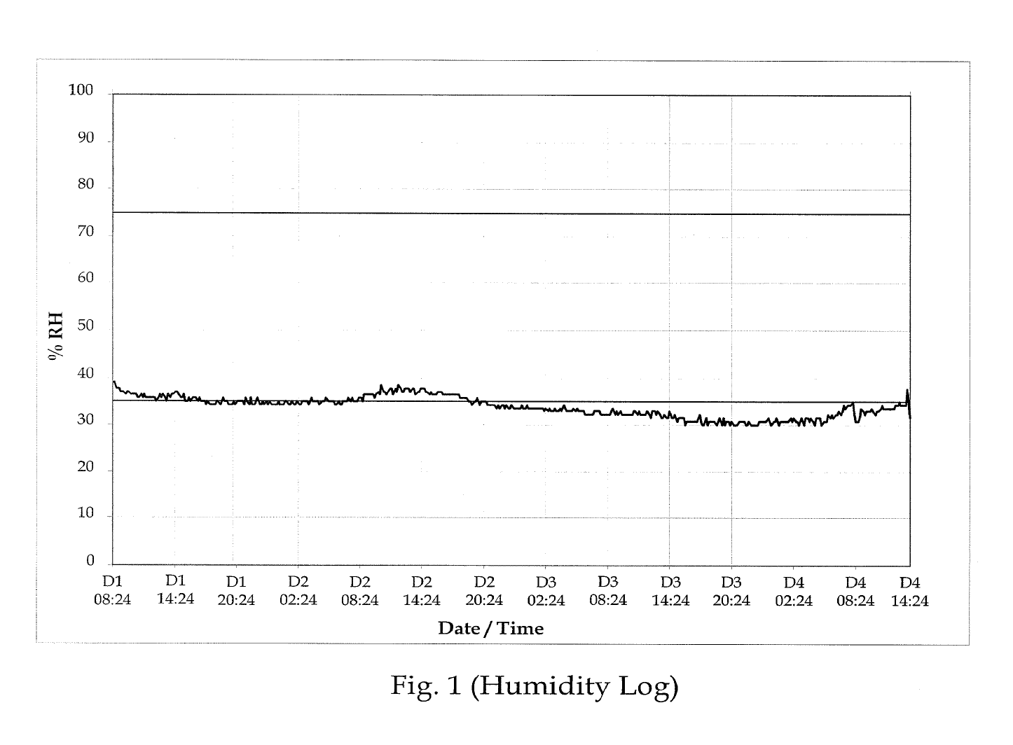

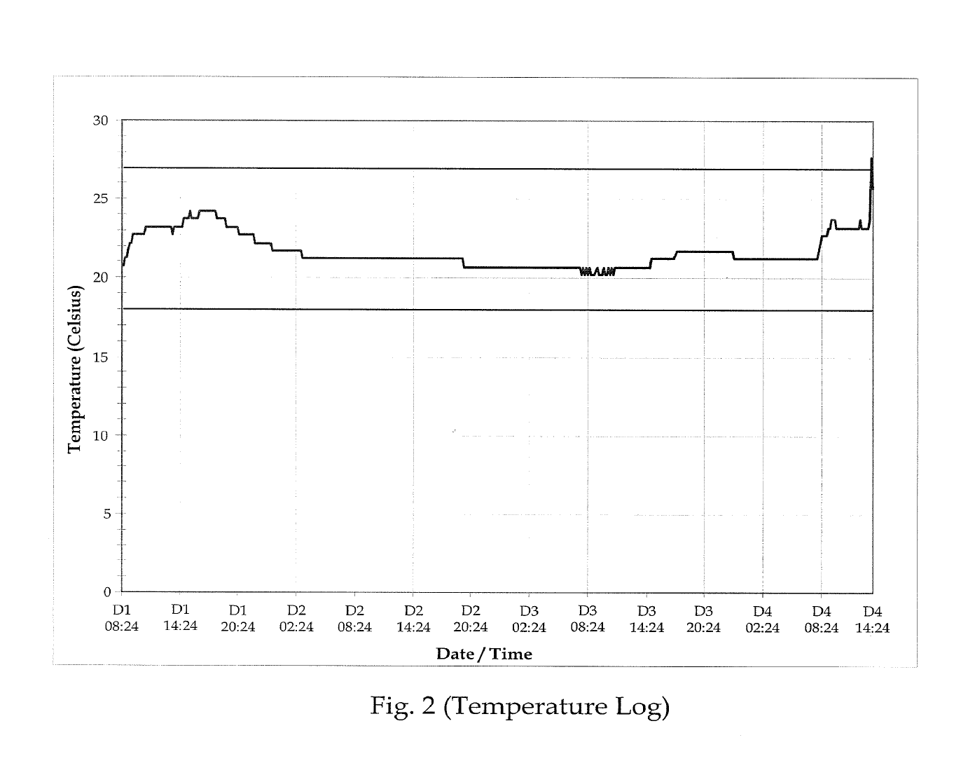

An exemplary graph of a readout from a temperature and humidity logging device is shown in FIGS. 1 and 2, which show an exemplary snapshot of a few days for which the temperature and humidity logging device was recording information from the area to be analyzed.

As shown in FIGS. 1 and 2, the humidity fluctuated between 30% and 40% relative humidity during the days studied. The temperature fluctuated between 20° C. and 24° C. until a spike to 28° C. at the end of the measurement period. However, this temperature spike could be accounted for as the removal of the temperature and humidity logging device into an outside environment or other explanation.

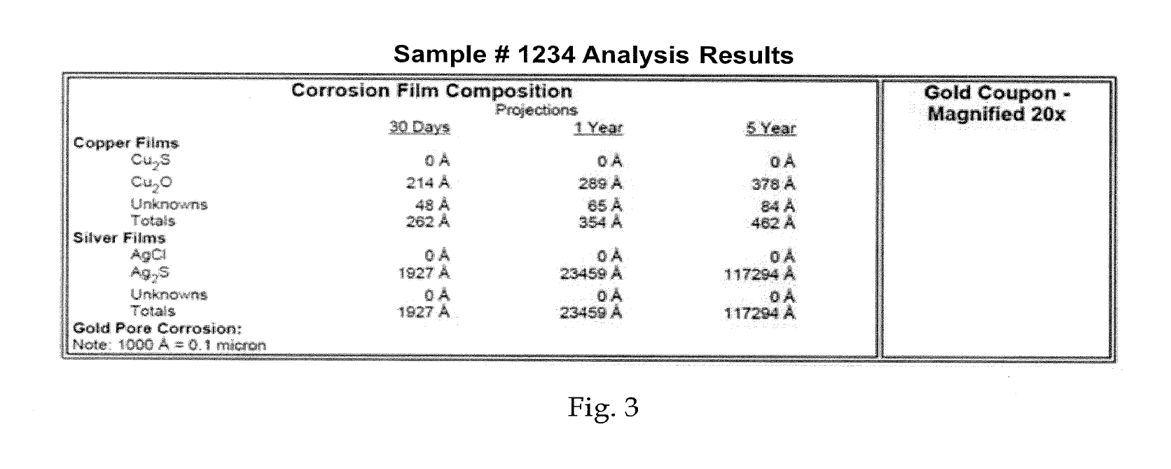

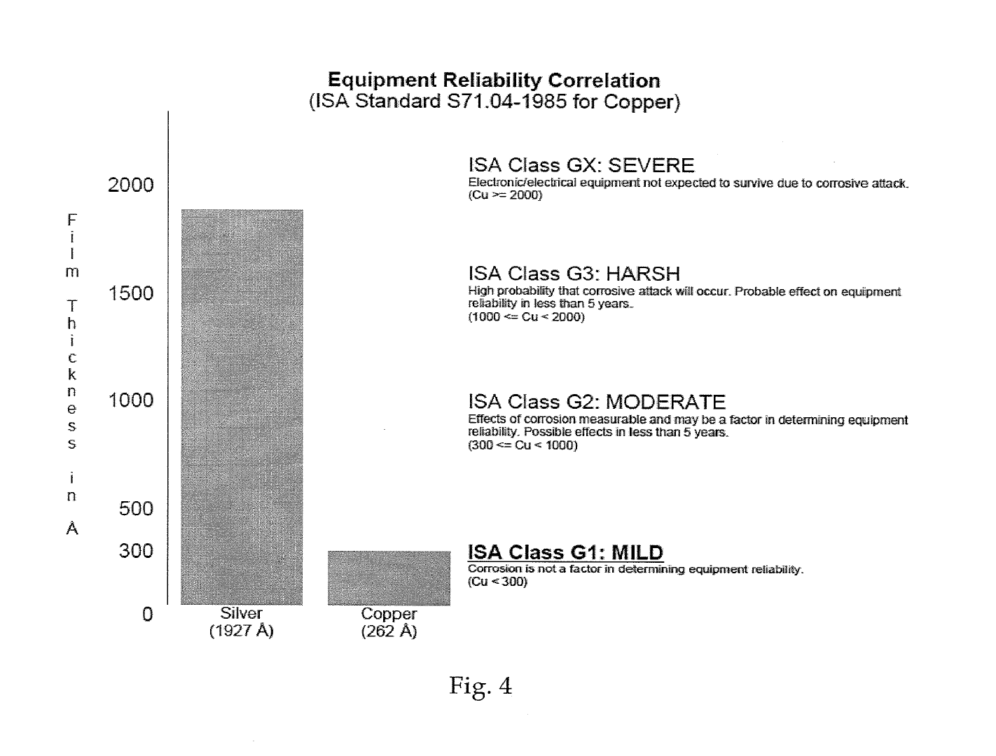

In addition to the information from the temperature and humidity logging device being reviewed, that information would be combined with a report analyzing the environmental reactivity coupons. An exemplary report from these coupons is included as FIGS. 3 and 4.

FIG. 3 shows an exemplary analysis of the composition of the corrosion film on both a copper and a silver coupon. FIG. 4 shows the Equipment Reliability Correlation, from the ISA standard S71.04-1985 described above, based on the corrosion analysis provided in FIG. 3. As shown in FIG. 4, based upon the high level of corrosion on the silver coupon after only 30 days (1927 A), the corrosion level would be classified at the upper range of G3/Harsh (almost to GX/Severe). The analysis report could also be configured to provide temperature and humidity data received from a temperature and humidity logger such as the Maxim iButton described above.

The information from the temperature and humidity logging device in conjunction with the information from the environmental reactivity coupons provides a cost-effective look into the environment in the area being studied. Since AMCs are not the only reason that corrosion occurs in the above described situations, additional information regarding other corrosive factors including increased temperature and/or humidity gives a greater view of what is occurring in the environment being studied. For example, if the environmental corrosion coupons show a “Harsh” environment under ISA standard S71.04-1985 and the data logger shows that there was a drastic increase in humidity for three days during the study of the area, it could be necessary to do another study once the humidity is stabilized since humidity increases the rate of corrosion due to environmental factors. If the humidity and temperature were stable and a “Harsh” reading was determined, it would be clear that remedial measures were necessary to ensure the continued operation of the equipment. In addition, temperature also has an effect on the rate of corrosion. A steady humidity with a temperature elevation could also be the cause of an abnormally high corrosion reading and would need to be further studied. By having this additional information, the owner of the area being studied is better equipped to infer what is causing the corrosion readings and how to best correct the corrosion issue based on the additional humidity and temperature information.

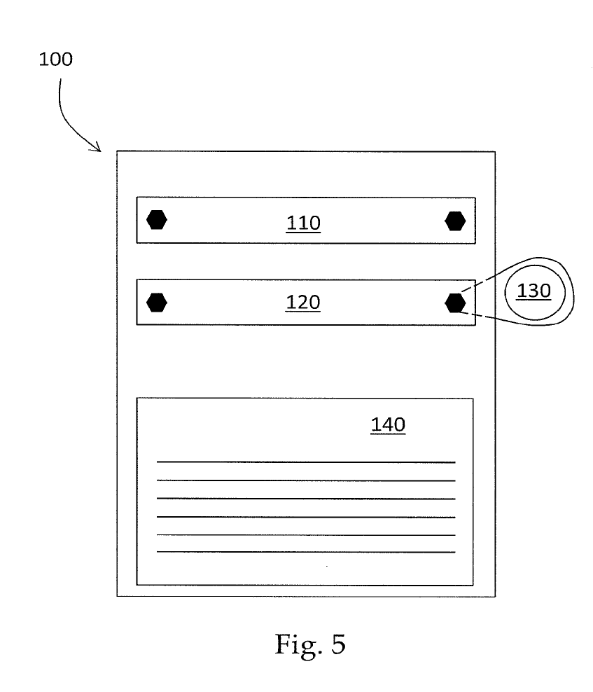

Also provided herein is an apparatus for passively monitoring corrosive factors in an environment that incorporates a temperature and humidity logging device in conjunction with environmental reactivity coupons. This apparatus would be placed in a location such as the locations described above. One example of such an apparatus is shown in FIG. 5. This apparatus 100 could be placed in an environment to be studied. After a time period, such as 30 days, the apparatus 100 would be removed and its data recovered using the above method. In one embodiment, an exemplary apparatus includes a copper corrosion classification coupon 110, a silver corrosion classification coupon 120, a temperature and humidity logger 130 and a label 140.

In the presence of adverse environmental conditions such as high temperature, high humidity, or corrosive gases one or both of the copper corrosion classification coupon 110 and silver corrosion classification coupon 120 will corrode, causing a corrosion layer to form on the corrosion classification coupons. The thickness of the corrosion layer on each corrosion classification coupon can be measured, providing an indication that a corrosive environment exists in the location where the apparatus was placed. While the embodiment of FIG. 5 shows only two corrosion monitoring corrosion classification coupons, it will be recognized that other metals could be used in place of or in addition to the copper and silver corrosion classification coupons shown.

The temperature and humidity logger 130 may be, for example, a Maxim iButton such as that described above. The logger 130 measures and records temperature and relative humidity conditions. The data from the logger 130 may be recovered to provide further information to identify the presence of a corrosive environment in the space being monitored.

Label 140 provides identifying information for the apparatus 100, including but not limited to the company name/address, identification of the space in which the apparatus 100 was placed, date and time that the apparatus 100 was placed in and removed from the space, and other identifying information.

The present invention thus provides an economical, easy to use corrosion monitoring apparatus 100 that can be installed by a layman in a space to be monitored (e.g., a data center), left for a designated amount of time (e.g., 30 days), and then recovered and mailed to an analysis facility. The analysis facility will conduct testing on the apparatus 100 and provide a report to the user, which could help the user in determining possible causes for contamination in the environment, including excessive temperature or humidity conditions or the presence of corrosive gases in the environment.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

That which is claimed is:

1. A method for passively monitoring corrosive factors in an environment, comprising:
locating an apparatus in the environment, the apparatus comprising at least one corrosion classification coupon and a temperature and humidity logging device;
maintaining the apparatus in the environment for a period of time;
removing the apparatus from the environment; and
analyzing the at least one corrosion classification coupon and the temperature and humidity logging device to determine whether one or more of corrosive gases, temperature changes or humidity changes were present in the environment during the period of time.

2. The method of claim 1, wherein the apparatus further comprises an identification label.

3. The method of claim 1, wherein the apparatus comprises at least two corrosion classification coupons, at least one of the corrosion classification coupons being a copper corrosion classification coupon and at least another of the corrosion classification coupons being a silver corrosion classification coupon.

4. The method of claim 3, wherein the apparatus further comprises more than two corrosion classification coupons.

5. The method of claim 1, wherein the temperature and humidity logging device is an electronic temperature and humidity logging device.

6. The method of claim 1, wherein the environment contains electronics or electronic equipment susceptible to airborne molecular contaminants.

7. The method of claim 1, wherein the period of time is at least 30 days.

8. The method of claim 1, wherein analyzing the at least one corrosion classification coupon comprises determining the reactivity rate of corrosion on the at least one corrosion classification coupon.

9. The method of claim 8, wherein analyzing the at least one corrosion classification coupon further comprises classifying the severity of corrosiveness in the environment based on the reactivity rate of corrosion on the at least one corrosion classification coupon in accordance with ISA standard S71.04-1985.

10. The method of claim 9, further comprising using the corrosiveness classification in combination with the determination of whether temperature changes or humidity changes were present in the environment during the period of time to infer that:
one or more corrosive gases were present in the environment and remedial measures are needed;
the method should be performed again due to unstable humidity conditions during the period of time; or
further analysis is required due to an increase in temperature and an abnormally high corrosiveness classification with steady humidity readings during the period of time.

11. The method of claim 1, wherein the analysis is performed by an off-site vendor.

12. The method of claim 1, wherein the temperature and humidity logging device is located in close proximity to the environmental reactivity coupons.

13. An apparatus for passively monitoring corrosive factors in an environment, comprising:
a first corrosion classification coupon;
a second corrosion classification coupon; and
an electronic temperature and humidity logging device.

14. The apparatus of claim 13, further comprising an identification label.

15. The apparatus of claim 13, wherein the first corrosion classification coupon is a copper corrosion classification coupon and the second corrosion classification coupon is a silver corrosion classification coupon.

16. The apparatus of claim 13, further comprising more than two corrosion classification coupons.

17. The apparatus of claim 13, wherein the temperature and humidity logging device is in close proximity to the environmental reactivity coupons.
